(19) United States
(12) Patent Application Publication
(10) Pub. No.: US 2004/0267912 A1
(43) Pub. Date: Dec. 30, 2004

(54) Non-standard MIME type supporting system of mobile terminal and method thereof

(75) Inventor: Sun-Mo Kim, Incheon (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/864,333

(22) Filed: Jun. 10, 2004

(30) Foreign Application Priority Data
Jun. 13, 2003 (KR) 38351/2003

(51) Int. Cl. G06F 15/177

(52) U.S. Cl. 709/220

(57) ABSTRACT

A method for downloading non-standard MIME type files onto a terminal including determining whether or not a type of the MIME file is supported by the terminal, and downloading a handler to process the MIME file if the type of MIME file is not supported by the terminal.

### CROSS-REFERENCE TO A RELATED APPLICATION

This application is related to Korean Application No. 38351/2003 filed on Jun. 13, 2003, the entire contents of which is incorporated by reference in its entirety.

### BACKGROUND OF THE INVENTION

1. Field of the Invention

The present invention relates to downloading applications onto a mobile terminal, and more particularly to downloading non-standard MIME (Multipurpose Internet Mail Extensions) type files onto the mobile terminal.

2. BACKGROUND OF THE RELATED ART

When a user downloads a file or application onto their mobile terminal, only standard MIME type files can be downloaded. The allowed standard MIME type files are previously established between the mobile communication provider and the manufacturer of the terminal. Further, MIME is a protocol that provides the ability to transfer non-textual files such as audio data, video data, image data, an application program, etc. A Simple Mail Transfer Protocol (SMTP) is a protocol that processes ASCII (American Standard Code for Information Interchange) data.

When a user requests an application (e.g., a Java application) or file be downloaded onto their terminal, a web server first transmits information regarding the data type, but does not transmit the data. In addition, the web server has to recognize the data type before transmitting the data to the client.

Further, the type of data to be transmitted is included in a HTTP (Hyper Text Transfer Protocol) header. HTTP is used to communicate between the server having the requested download file and the mobile terminal. However, as noted above, only standard MIME type files can be downloaded onto the mobile terminal.

### SUMMARY OF THE INVENTION

Accordingly, one object of the present invention is to address at least the above-noted and other problems.

Another object of the present invention is to allow non-standard type MIME files to be downloaded onto a terminal (e.g., mobile terminal, subscriber unit, user equipment (UE) etc.).

To achieve these and other objects, the present invention provides a novel method for downloading non-standard MIME type files onto a terminal including determining whether or not a type of the MIME file is supported by the terminal, and downloading a handler to process the MIME file if the type of MIME file is not supported by the terminal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings wherein:

FIG. 1 is an overview of a non-standard MIME type file supporting system according to the present invention; and

FIG. 2 is a flow chart illustrating a non-standard MIME type file downloading method according to the present invention.

### BEST MODE OF THE INVENTION

Referring now to the drawings, the present invention will be described.

As noted above, a user is only able to download standard MIME type files or applications that have been previously established by the terminal manufacturer and the mobile communications provider. However, one method of downloading a newly defined MIME type file (or a non-standard MIME type file) is for a user to purchase a new terminal that allows the transfer of such a file. Another method is to have new software, etc. of the terminal upgraded at a service center. However, these methods are inconvenient, expensive and generally problematic to the user, the mobile communications provider and the manufacturer of the terminal.

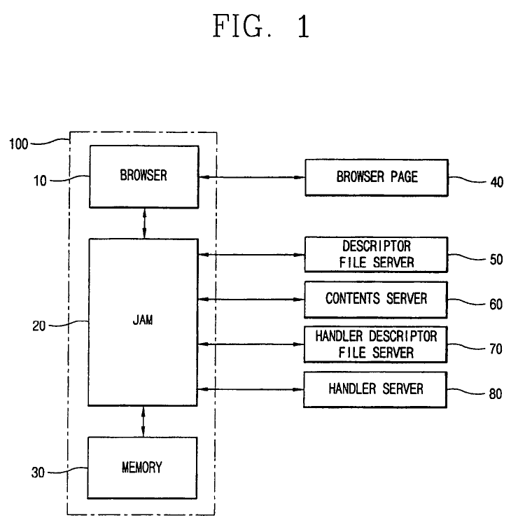

Turning now to FIG. 1, which illustrates a non-standard MIME type system including a terminal 100 having a browser 10 for requesting and receiving a descriptor file uniform resource locator (URL); a java application manager (JAM) 20 for searching a handler to process and download non-standard MIME type applications or files; and a memory 30 for storing handlers and contents downloaded by the JAM 20. Also shown is a browser page 40 for transmitting the descriptor file URL to the browser 10; a descriptor file server 50 for transmitting a descriptor file to the JAM 20; a contents server 60 for transmitting the requested contents to the JAM 20; a handler descriptor file server 70 for transmitting a handler descriptor file based on the handler descriptor file URL to the JAM 20; and a handler server 80 for transmitting a handler to the JAM 20.

Further, the terminal 100 downloads data by communicating with each server using HTTP, for example. In addition, the browser 10 of the terminal 100 requests a descriptor file URL from the browser page 40. A header field of the received descriptor file URL also includes information regarding the type of MIME file. If the received descriptor file URL is a non-standard MIME type file, the browser 10 transmits the descriptor file URL and the type of non-standard MIME to the JAM 20.

The JAM 20 then receives the descriptor file URL and the non-standard MIME type file from the browser 10 and searches whether or not a handler for processing the non-standard MIME type is registered in the memory 30. If the handler of the non-standard MIME file is not found, a handler for processing the non-standard MIME file is downloaded from the handler server 80. Further, the requested contents of the non-standard MIME type files are then downloaded from the contents server 60.

In addition, to download the handler for processing the non-standard MIME type file, a request URL (which has a pre-defined format) is prepared by the JAM 20 and sent to the browser 10. The browser 10 then sends the JAM 20 a handler descriptor file URL. The format of the request URL includes the pre-defined request URL and data regarding the type of the MIME file. Further, the JAM 20 uses the handler descriptor file URL to download the appropriate handler descriptor file from the handler descriptor file server 70. The contents of the non-standard MIME type file may then be downloaded from the contents server 60.

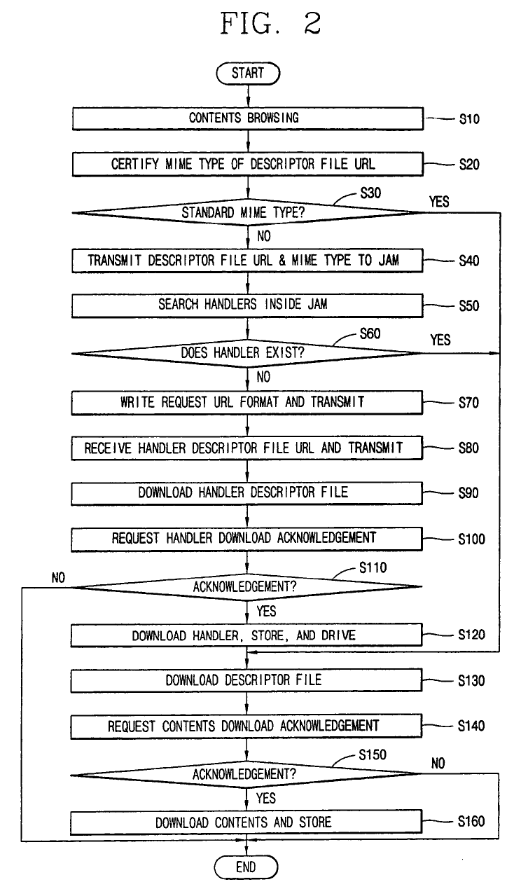

Turning now to FIG. 2, which is a flow chart illustrating a method for downloading non-standard MIME files according to the present invention.

As shown, the browser 10 is driven by a predetermined external signal, such as by a user operating the terminal, a wireless application protocol (WAP) push request, a text service, etc., thereby allowing the user to browse applications (step S10). The browser 10 of the terminal 100 then requests a descriptor file URL of the browser page 40, and appropriately receives data including the descriptor file URL from the browser page 40. As discussed above, the terminal 100 and the browser page 40 communicate with each other using HTTP, for example. Further, the MIME type and the descriptor file URL are included in a header field of the HTTP frame of the descriptor file URL.

Then, the browser 10 detects the MIME type information in the header field (step S20), and determines whether or not the MIME type file is a standard MIME type file that can be processed by the browser 10 (step S30). If the MIME data type can not be processed by the browser 10 (i.e., it is a non-standard MIME type file), the browser 10 transmits the descriptor file URL and the MIME type to the JAM 20 (step S40). The JAM 20 then searches the memory 30 to determine if there is an available handler that can process the non-standard MIME type application (step S60).

If a handler for processing the non-standard MIME type file does not exist in the memory 30 (no in step S60), the JAM 20 prepares a request URL using a pre-defined format and sends the request URL to the browser 10 (step S70). As noted above, the request URL format includes the request URL and information regarding the non-standard MIME type. Then, the browser 10 retrieves a handler descriptor file URL and transmits the handler descriptor file URL to the JAM 20 (step S80). The request URL to which the browser has accessed can be a handler server or a browser page. Subsequently, the JAM 20 receives the handler descriptor file URL from the browser 10 and accesses the handler descriptor file server 70, to download the appropriate handler descriptor file (step S90). Then, the JAM 20 requests the user acknowledge whether or not the handler is to be downloaded by displaying a text message, etc. on a display unit of the terminal 100 (step S100).

If the user requests the handler be downloaded (yes in step S110), the JAM 20 accesses the handler server 80 to download the appropriate handler, and stores the handler in the memory 30 (step S120). If the user does not request the handler be downloaded (no in step S110), the terminal 10 completes the operations and enters into an idle state.

Further, when the user requests the handler be downloaded, the handler for processing the non-standard MIME type is downloaded and registered in the memory 30. Then, when the browser 10 accesses the browser page 40 after the handler is registered, the JAM 20 drives the registered handler to receive a new service or contents provided by the mobile communication provider or the contents provider. That is, after the handler is registered in the memory 30, the necessary handler for processing the non-standard MIME type is now used.

Further, the JAM 20 accesses the descriptor file server 70 through the received descriptor file URL to download a descriptor file (step S130), and requests the user acknowledge whether or not the contents are to be downloaded (step S140). If the user requests the contents be downloaded (yes in step S150), the JAM 20 accesses the contents server 60 to download the contents and stores the contents in a predetermined region of the memory (step S160). If the user does not request the contents be downloaded (no in step S150), the terminal 100 completes the operations and enters into an idle state.

Further, if the received MIME type file is a standard MIME type file (yes in Step S30), the JAM 20 accesses the descriptor file server 50 to download the descriptor file (step S130). Steps 140, 150 and 160 are then executed.

Thus, even if the mobile communication provider or the contents provider provides a new service or contents, a handler for processing a non-standard MIME type service or contents can be downloaded. Accordingly, the user can easily handle non-standard MIME types. Further, the mobile communication provider or the contents provider can easily provide new services regardless of the type of the terminal.

In addition, the browser page 40, the descriptor file server 50, the contents server 60, the handler descriptor file server 70, and the handler server 80 may be a single unit or may be separate units, for example.

This invention may be conveniently implemented using a conventional general purpose digital computer or microprocessor programmed according to the teachings of the present specification, as well be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium including instructions which can be used to program a computer to perform a process of the invention. The storage medium can include, but is not limited to, any type of disk including floppy disks, optical discs, CD-ROMs, and magneto-optical disks, ROMs, RAMs, EPROMs, EEPROMs, magnetic or optical cards, or any type of media suitable for storing electronic instructions.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method for downloading a non-standard MIME (Multipurpose Internet Mail Extensions) type application to a terminal comprising:
judging a type of the MIME application from a received descriptor file Uniform Resource Locator (URL);
if the type of the MIME application is a non-standard MIME type as a result of the judgment, determining whether or not a handler for the non-standard MIME type application exists in a memory of the terminal; and
if the handler for the non-standard MIME type application does not exist in the memory of the terminal as a result of the judgment, downloading a handler descriptor file from an external server.

2. The method of claim 1, wherein if the handler for the non-standard MIME type application does not exist, the method further comprises:
sending a prepared request URL to a browser and receiving a handler descriptor file URL from the browser that corresponds to the prepared request URL; and
downloading the handler descriptor file from the external server using the handle descriptor file URL.

3. The method of claim 2, wherein the request URL includes the handler descriptor file URL and data regarding the type of the non-standard MIME application.

4. The method of claim 1, further comprising:
if a handler for the received non-standard MIME type application exists in the memory of the terminal, using that handler to process contents of the non-standard MIME type application.

5. The method of claim 1, further comprising:
if the type of the MIME application is a standard MIME type application as a result of the judgment, downloading the descriptor file.

6. The method of claim 1, wherein the browser receives the descriptor file URL from a browser page based on a request.

7. The method of claim 1, further comprising:
downloading a handler from an external server based on the downloaded handler descriptor file.

8. The method of claim 7, further comprising storing the downloaded handler in the memory of the terminal.

9. A system for downloading a non-standard MIME (Multipurpose Internet Mail Extensions) type application onto a terminal, comprising:
a terminal including a browser, a java application manager (JAM) and a memory;
a browser page for transmitting a descriptor file Uniform Resource Locator (URL) to the browser;
a descriptor file server for transmitting a descriptor file corresponding to the descriptor file URL to the JAM;
a handler descriptor file server for transmitting a handler descriptor file to the JAM;
a handler server for transmitting a handler to the JAM; and
a contents server for transmitting contents of the MIME application to the JAM.

10. The system of claim 9, wherein the terminal communicates with the browser page, the descriptor file server, the contents server, the handler descriptor filer server, and the handler server using a HyperText Transfer Protocol (HTTP).

11. The system of claim 9, wherein the browser page, the descriptor filer server, the contents server, the handler descriptor filer server, and the handler server are a single unit or are separate units.

12. The system of claim 9, wherein the JAM searches the memory of the terminal for a handler that can process the non-standard MIME application and downloads a handler from an external handler server if the handler is not stored in the memory of the terminal.

13. A method for downloading non-standard MIME (Multipurpose Internet Mail Extensions) type application onto a terminal, comprising:
determining whether or not a type of MIME application is supported by the terminal; and
downloading a handler to process the MIME application if the type of the MIME application is not supported by the terminal.

14. The method of claim 13, wherein downloading the handler comprises:
downloading the handler from an external server having handlers to process the non-supported MIME type application if a handler to process the non-supported MIME application does not exist in a memory of the terminal.

15. The method of claim 13, wherein downloading the handler comprises:
retrieving a handler description file URL from an external handler descriptor file server; and
downloading the handler from the external server based on the handler descriptor file URL.

16. The method of claim 13, wherein downloading the handler comprises:
prompting a user of the terminal to acknowledge the handler be downloaded prior to downloading the handler.

17. The method of claim 13, further comprising:
downloading contents of the non-supported MIME type.

18. The method of claim 17, wherein downloading the contents comprises:
prompting a user of the terminal to acknowledge downloading of the contents prior to downloading the contents.

19. The method of claim 13, wherein determining whether or not the type of MIME application is supported comprises:
reading a header file of an HTTP message.
